(19) United States
(12) Patent Application Publication
(10) Pub. No.: US 2015/0269642 A1
(43) Pub. Date: Sep. 24, 2015

(54) INTEGRATED SHOPPING ASSISTANCE FRAMEWORK

(71) Applicants: Danqing CAI, Singapore (SG); Ziheng LIN, Singapore (SG); Subashini RENGARAJAN, Singapore (SG); Abraham Sasmito ADIBOWO, Singapore (SG); Haiyun LU, Singapore (SG); Satya Ashok SREENIVASAN, Singapore (SG)

(72) Inventors: Danqing CAI, Singapore (SG); Ziheng LIN, Singapore (SG); Subashini RENGARAJAN, Singapore (SG); Abraham Sasmito ADIBOWO, Singapore (SG); Haiyun LU, Singapore (SG); Satya Ashok SREENIVASAN, Singapore (SG)

(21) Appl. No.: 14/217,507

(22) Filed: Mar. 18, 2014

(51) Int. Cl. G06Q 30/06; G06Q 30/02

(52) U.S. Cl. CPC G06Q 30/0613; G06Q 30/0251; G06Q 30/0605

(57) ABSTRACT

Described herein is a framework for an integrated shopping assistance. In accordance with one aspect, the framework may detect a customer in an establishment. The framework may detect the customer by determining location proximity data of one or more detected customer-registered devices in an establishment. The framework may further perform, based on one or more data sources, image recognition of a captured image of a customer. Information associated to the customer may be retrieved from the one or more data sources. Real-time analytics may further be performed based at least in part on the location proximity data and the retrieved customer information. The framework may present, via a client device, a notification based on the location proximity data, a verification of the customer, the associated customer information, and results of the analytics.

### TECHNICAL FIELD

The present disclosure generally relates to systems and methods for an integrated shopping assistance framework.

### BACKGROUND

Physical retail stores present an information barrier between customers and retailers. Such information barrier may be measured by parameters such as conversion rate, which may be calculated as the number of sales transaction divided by the number of customer visits. Typically conversion rate of physical retail stores is lower than 20%. A low conversion rate may indicate that the information barrier prevents customers from buying and retailers from selling.

The information barrier poses challenges to both retailers and customers. For example, retailers are unable to identify customers with the intention to purchase a product, which may cause loss of potential sales as retailers are unable to effectively engage customers with relevant product recommendations. Furthermore, physical stores may not be strategically located in an establishment, or may be located at an area with poor customer traffic. In such instances, the physical retail store may not be easily noticed by customers, and may be at risk of underperforming due to lack of customer patronage. The retailer may resort to offering promotions and sales to attract customers, however, such efforts may be futile especially when there is a lack of information transparency and effective information distribution between the physical retail stores and potential customers. In most cases, retailers are also unable to gauge their performance as analyses based on, for example, customer visits or transactions, are not readily available in real time.

From the customer's perspective, there is a mismatch between their preferences and the current products that are available in-store. Moreover, customers may not have time to search for a specific product amongst the vast ranges of products that are available in the physical retail stores of a shopping establishment, and at times it may be stressful for customers to search for an item from the plethora of available items that actually matches their preferences. The lack of information transparency not only hinders customers from a fulfilling shopping experience but is also detrimental to the return of investment for physical store retailers.

Therefore, there is a need for a framework that addresses the above-mentioned challenges.

### SUMMARY

The present disclosure relates to a framework for an integrated shopping assistance. In accordance with one aspect, the framework may detect a customer in an establishment. The framework may perform, based on one or more data sources, image recognition of a captured image of the customer. Information associated to the customer may further be retrieved from the one or more data sources. A verification of the customer and the associated customer information may be presented. Real-time analytics may further be performed based at least in part on data associated to the detection of the customer in the establishment, and results of the analytics may then be presented.

In accordance with another aspect, the framework may determine location proximity data of one or more detected customer-registered devices in an establishment. The framework may further perform, based on one or more data sources, image recognition of a captured image of a customer. Information associated to the customer may be retrieved from the one or more data sources. Real-time analytics may further be performed based at least in part on the location proximity data and the retrieved customer information. The framework may present, via a client device, a notification based on the location proximity data, a verification of the customer, the associated customer information, and results of the analytics.

With these and other advantages and features that will become hereinafter apparent, further information may be obtained by reference to the following detailed description and appended claims, and to the figures attached hereto.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings. Furthermore, it should be noted that the same numbers are used throughout the drawings to reference like elements and features.

FIG. 1 shows an exemplary architecture;

FIG. 2 is a flow diagram illustrating an exemplary method of shopping assistance based on device detection;

FIG. 3 illustrates an exemplary dashboard that shows the presence of one or more customers in a shopping establishment;

FIG. 4 illustrates an exemplary promotion-based advertisement that may be presented to a customer via a customer device;

FIG. 5 shows an exemplary dashboard for uploading a promotional product advertisement to an advertisement repository;

FIG. 6 illustrates an exemplary dashboard that allows configuration of notifications;

FIG. 7 is a flow diagram illustrating an exemplary method of shopping assistance based on image recognition;

FIG. 8 illustrates an exemplary dashboard that shows a recognized image of a customer and the associated customer information presented at a client device;

FIG. 9 illustrates an exemplary dashboard of an analytics report; and

FIG. 10 illustrates another exemplary dashboard of an analytics report.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for providing an integrated shopping assistance between retailers and customers is described herein. More particularly, the present framework includes customer detection capabilities to communicate information of customers to retailers, and analytics capabilities to provide, for example, commercial information based on real time analyses. Examples of customers include regular shoppers, potential customers, consumers, and the likes.

The framework may employ sensors installed in an establishment such as a shopping facility to detect and recognize on-premise customers so as to assist retailers in identifying potential customers. In some instances, the framework may employ one or more mobile applications installed in customer devices to facilitate the detection of a customer. The framework may leverage upon various platforms such as loyalty program membership database, social networking sites, third party systems, etc., to retrieve information of the detected customer. Based on the retrieved customer information, the present framework may provide retailers with valuable insights into a customer's profile and shopping preferences, and assist retail personnels in determining relevant product recommendations (e.g., discounts, personalized promotions, new products, popular items, etc.) that may be provided to that customer.

In some implementations, the framework may assist retail personnels in recognizing a loyal customer in real time based on location proximity detection and/or image recognition of the customer when he or she visits a particular retail store. In one aspect, the framework may also recognize a customer with an intention of purchasing products. For example, the customer may have indicated his or her interest in a product in a mobile application or on any searchable media (e.g., online retail sites, social networking sites, web logs, etc.). The framework may provide the retail personnel with the customer information such as, for example, the customer's identity, profile, purchase history, and shopping list. Such customer information facilitates the retail personnel in engaging the customer with the right context (e.g., the right time, the right place, the right product recommendation, etc.). The framework may then perform analytics on, for example, information related to the customer's visit and transactions to automatically present real time in-store commercial analyses.

Another aspect of the framework enables retail operators, advertisement sponsors, third party operators, and other stakeholders to present product information (e.g., advertisements, promotions, etc.) to customers, while customers may consume and benefit from product offerings based on the information that they have received. In other aspects, the mobile application(s) may, in response to customer requests, facilitate contextual-based product searches (e.g., what are available in the proximity of the retail facility, associated offers, recommendation by other shoppers, etc.). Such information may be recorded for analyses by the framework, and the framework may present analytics results such as, for example, transactions analyses to retailers in real time.

In some implementations, the framework allows multiple independent retailers to use one common system and in some cases, a common mobile application (mobile app) may be employed on a customer device. A customer may access and receive shopping assistance in any participating retail establishment through that common mobile app. For example, a common mobile app may be employed by multiple independent retailers who share the same venue (e.g., shopping mall), or retail chains in different venues, where each retail unit may access the system via a unique retailer identifier or login protocol. In other cases, each individual retailer may employ separate mobile applications on a customer device.

It should be appreciated that the framework described herein may be implemented as a method, a computer-controlled apparatus, a computer process, a computing system, or as an article of manufacture such as a computer-usable medium. These and various other features will be apparent from the following description.

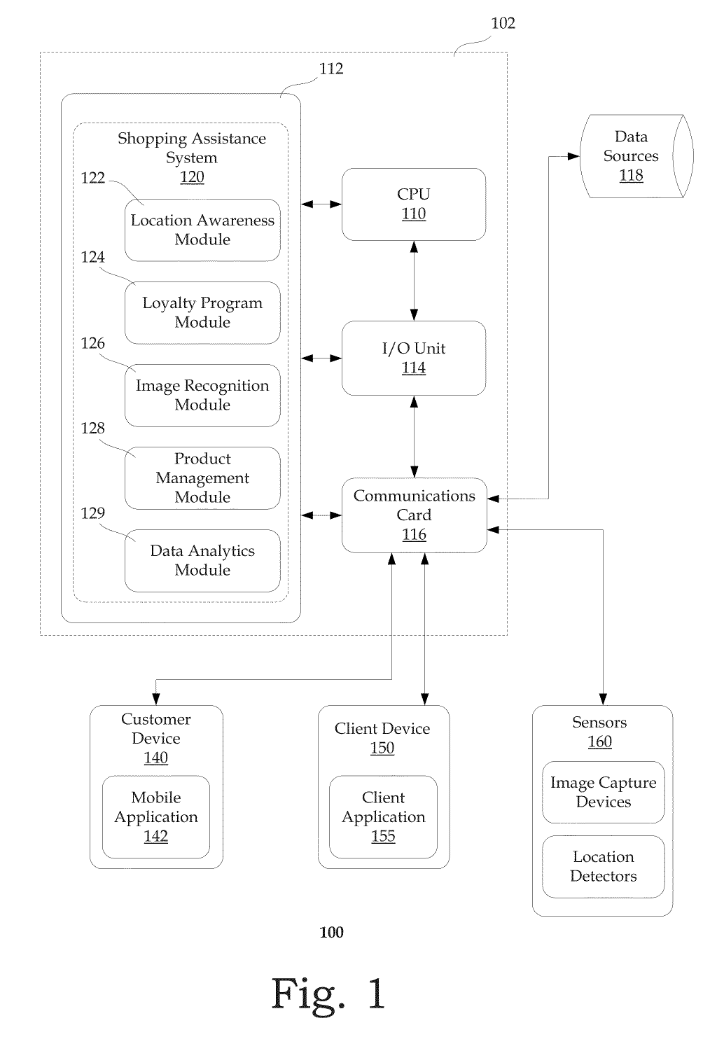

FIG. 1 shows an exemplary architecture 100 that may be used to implement the framework described herein. Generally, exemplary architecture 100 may include a computer system 102, one or more data sources 118, one or more customer devices 140, one or more client devices 150, and multiple sensors 160.

Computer system 102 can be any type of computing device capable of responding to and executing instructions in a defined manner, such as a workstation, a server, a portable laptop computer, another portable device, a mini-computer, a mainframe computer, a storage system, a dedicated digital appliance, a device, a component, other equipments, or some combination of these. Computer system 102 may include a central processing unit (CPU) 110, a memory module 112, an input/output (I/O) unit 114 and a communications card or device 116 (e.g., modem and/or network adapter) for exchanging data with a network (e.g., local area network (LAN), wide area network (WAN), Internet, etc.). It should be appreciated that the different components and sub-components of the computer system 102 may be located or executed on different machines or systems. For example, a component may be executed on many computer systems connected via the network at the same time (i.e., cloud computing).

Computer system 102 may further be communicatively coupled to one or more data sources 118. A data source 118 may be, for example, any database (e.g., relational database, in-memory database, etc.), a repository, an entity (e.g., set of related records), or a data set included in a database, website or third-party system. In some implementations, data sources 118 include a retail operator's system (e.g., Enterprise Information Management server, POS system, inventory, etc.), a third-party system (e.g., personalized shopping applications, etc.), social network sites, or a combination thereof.

In some implementations, computer system 102 is communicatively coupled to sensors 160, such as signal detectors (e.g., Wi-Fi, Bluetooth, Radio-frequency identification or RFID signal detector), positioning sensors (e.g., Wi-Fi positioning sensors, proximity sensors, indoor positioning systems, etc.), image sensors (e.g., camera), audio sensors (e.g., microphone), and so forth. Such sensors 160 may be standalone, or incorporated in client devices 150 and/or customer devices 140. In some instances, positioning sensors 160 serve to provide a location of, for example, a customer device when it is inside a building. The positioning sensors 160 may rely on nearby anchors (i.e. nodes with a known position), which either actively locate tags or provide environmental context for devices to sense in order to provide location information. In some implementations, image sensors 160 serve to detect and capture facial image of customers.

Computer system 102 may act as a server (e.g., cloud server) and operate in a networked environment using logical connections to one or more customer devices 140 and one or more client devices 150. Each customer device 140 may be associated with one or more customers, and serve as an interface to send and receive information from computer system 102. In some implementations, a customer device 140 is a mobile device that includes, but is not limited to, a smart phone, a tablet computer, a handheld laptop, a cellular device, a mobile phone, a gaming device, a portable digital assistant (PDA), a portable media player, a wireless device, a data browsing device, and so forth. Customer device 140 may include components similar to a computer system, such as an input device for receiving and processing user input (e.g., touch screen, keypad, freeform text recognition module, speech recognition module, etc.), an output device for displaying a graphical user interface, a communications card, memory for storing a mobile software application (or mobile app) 142 and data, a processor for executing the mobile app 142, and so forth.

A mobile app 142 may be installed on customer device 140 to facilitate the detection of the customer device 140. For example, upon installation, the mobile app 142 may automatically register a unique identifier of the customer's device (device ID), such as the device MAC address, and store it into a shopping assistance system, registering the customer device. The shopping assistance system may include a memory 112 or a database 118 for storing the device ID. The mobile app 142 may further register a customer's loyalty program membership data into the shopping assistance system as the app is installed into the customer device. For instance, the customer's loyalty program membership data such as, for example, customer name or member ID, may be input manually by the customer or by scanning data from retailers' information system in data sources 118. For example, the mobile app 142 may be integrated with a loyalty program manager that allows a user to enter and view membership information via a user interface. The loyalty program membership data may be associated with one or more retailers. In some implementations, the framework may employ more than one type of mobile application in user device 140. For example, the mobile app may not necessarily be a shopping assistance-based app.

In the case where the user of the customer device 140 is not a member of the loyalty program, the customer may apply through the mobile app. For example, the mobile app may provide an electronic application for the user to fill, registering the user as a new member of a loyalty program.

Switching on the Wi-Fi function on a registered customer device enables its detection by sensors 160 of the shopping assistance system. When a registered device ID is detected, the device ID is used as an index to search for customer loyalty membership data. For example, information associated with the registered customer is retrieved.

Mobile app 142 may serve to present a user interface or dashboard to access shopping assistance services, including services provided by computer system 102. The user interface may present product information provided by the computer system 102 or client device 150 (e.g., product catalogue, promotions, relevant deals from retailers, new product information, push notifications, etc.). For example, promotions may be pushed to the customer device 140 based on device settings that allow the device to accept notifications. Such push notifications may be provided even when the mobile app 142 is not actively running In some instances, mobile app 142 may also collect and store customer information (e.g., purchase history, product search history, etc.).

Client devices 150 serve as an interface to send and receive information from computer system 102. A client device may be associated with one or more clients (e.g., retailer system operator, retail manager, retail personnel, third-party provider operators, etc.). For example, each client device may be associated with one or more clients. The client devices 150 may be desktop computers, mobile devices (e.g., smartphones, tablets, handheld laptops, wireless devices, data browsing devices, etc.), wearable computers (e.g., Google Glass, etc.) and so forth. Client devices 150 may include components similar to a computer system, such as an input device for receiving and processing user input (e.g., touch screen, keypad, image recognition module, etc.), an output device for displaying a graphical user interface, a communications card, memory for storing a client application 155 and data (e.g., enterprise information management data), a processor for executing the client application 155, and so forth. Such devices may be positioned at a static workstation, physically hand-held, worn, or carried by, for example, retail staff in a shopping establishment.

Memory module 112 of the computer system 102 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof. Memory module 112 serves to store machine-executable instructions, data, and various software components for implementing the techniques described herein, all of which may be processed by CPU 110. As such, the computer system 102 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In some implementations, memory module 112 of the computer system 102 includes a shopping assistance system 120 for implementing the techniques described herein. The shopping assistance system 120 may include, but is not limited to, a location awareness module 122, a loyalty program module 124, an image recognition module 126, a product management module 128, a data analytics module 129, and so forth. It should be understood that less or additional components may be included in the shopping assistance system 120, and that some or all of these exemplary components may also be implemented in another computer system (e.g., client device 150).

Location awareness module 122 may serve to monitor the presence of customers in an establishment by, for example, detecting customer devices via one or more sensors through the customer device IDs. In some implementations, location awareness module 122 may also determine the location proximity of the detected customer device. Loyalty program module 124 may facilitate in managing and storing membership information of customers who have registered to a loyalty program. As described, customers may be registered to a loyalty program upon installation of the mobile app(s) 142. The loyalty program module 124 may also be configured to access and retrieve information of registered customers that may be stored in data sources 118 such as a retailer information system database. The customer information may include, for example, a title (Mr./Mrs./Ms.), First Name, Last Name, Email address, device ID, link to customer's photo, membership classification, membership points accumulated, products that the customer have selected as “favourites” from an online catalogue, products that have been previously purchased from a retailer, and search history.

Image recognition module 126 serves to perform image recognition of images captured by one or more sensors 160 such as image recording devices, for example, CCTV cameras, camera installed on retail staff laptops etc. In some instances, image recognition module 126 may access data from multiple data sources 118. The product management module 128 may serve to obtain and manage, for example, product information, advertisements, promotions, promotion history, transaction information, and/or integration of retail store activities (e.g., in multiple branches, franchise, etc.). In other implementations, the product management module 128 facilitates product search, look-up for promotional offers, etc., by customers. In some aspects, a search may be recorded by the product management module 128 and automatically fed to the data analytics module 129.

The data analytics module 129 may serve to perform, for example, real time analyses of customer visits and any associated information such as conversion rate. In some implementations, the data analytics module 129 may produce analytics reports such as frequency of customer visits, conversion rate, footfall flow graph, and the likes. In other implementations, the data analytics module 129 may analyze customer purchase behaviors to generate a personalized promotion.

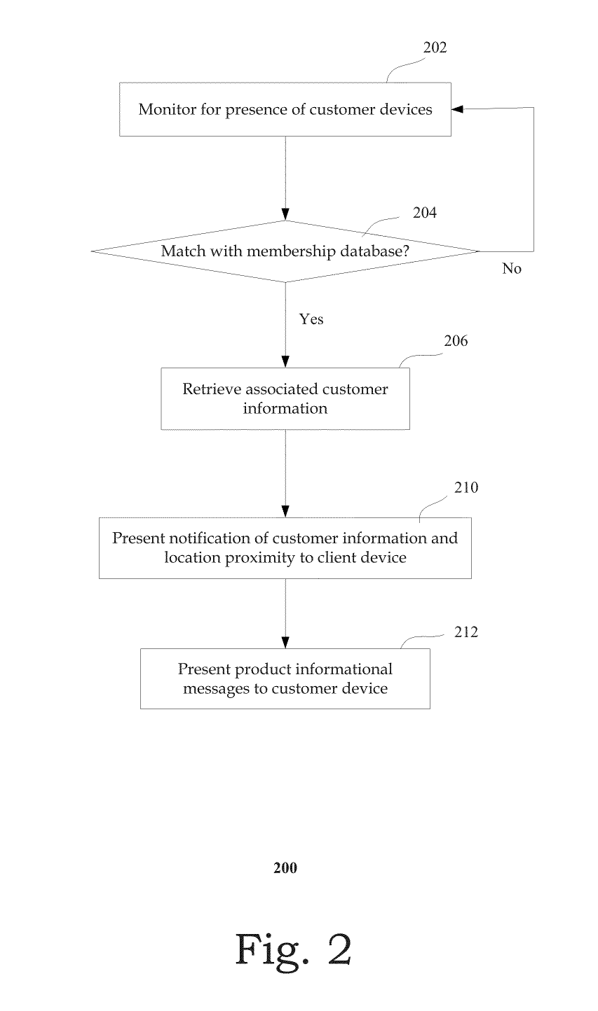

FIG. 2 shows an exemplary method 200 of shopping assistance based on device detection. The method 200 may be performed automatically or semi-automatically by the system 100, as previously described with reference to FIG. 1. It should be noted that in the following discussion, reference will be made, using like numerals, to the features described in FIG. 1.

At 202, location awareness module 122 monitors for the presence of a customer device 140 in an establishment (e.g., shopping mall, supermarket, etc.). For instance, location awareness module 122 may monitor for the presence of the customer device 140 via sensors 160. In some implementations, one or more sensors 160 may detect the customer device 140 based on Wifi signals. The sensors 160 may detect Wifi-enabled customer devices 140 within the range of Wifi signals. For example, when the customer device 140 is switched on and its Wifi function enabled, it can be detected by the sensors 160. The location awareness module 122 may identify the customer device 140 by its unique ID such as its MAC address. As described, the unique identifier of a customer's device may be registered upon installation of mobile app 142 into customer device 140. In some instances, the detection of the customer devices 140 may be independent of the mobile app 142 being actively running Other methods for detecting and locating the presence of a customer device 140 may also be useful.

In one implementation, location awareness module 122 detects and determines the location proximity of the customer device 140 based on positioning data provided by positioning sensors 160. For example, positioning sensors (e.g., indoor positioning system) may be strategically positioned in the shopping facility to automatically collect location proximity data of the customer device 140. Such positioning system may include, for example, YFind positioning system that employs Wifi signals.

At 204, the location awareness module 122 may compare the unique identifier of the detected on-premise customer device such as its MAC address with registered device IDs (e.g., MAC addresses) that are stored in shopping assistance system 120 or database 118. If no match is determined, the method 200 continues at 202 to monitor for presence of other customer devices. If a match is determined, the location awareness module 122 may identify a registered customer to be present in the establishment, and the method 200 continues at 206.

At 206, the loyalty program module 124 retrieves customer information associated with the customer of that detected customer device 140. For example, the registered device ID of the detected customer device 140 may be used as an index to automatically search for customer loyalty membership data such as name, membership ID, photo, loyalty points, contact number, home address, social comments, shopping preferences, shopping lists, frequented branches, favorite products, product search history, purchase history, and transaction history, which may include date/time of past purchases, purchased items, amount, venue, etc. The customer information may be retrieved from data residing locally in computer system 102, client device 150 of a retail operator, retailer information systems located in, for example, data sources 118, or data stored in a distributed fashion. In some instances, the loyalty program module 124 may mine for associated customer information (e.g., shopping list, past purchases) of the customer from searchable data sources 118 such as, for instance, social network sites. The loyalty program module 124 may mine for customer information based on, for example, customer behavior models or buying pattern models. Furthermore, if the retrieved loyalty membership data matches with a particular retailer's sales interest, the identified registered customer may be considered to be a potential customer for that retailer.

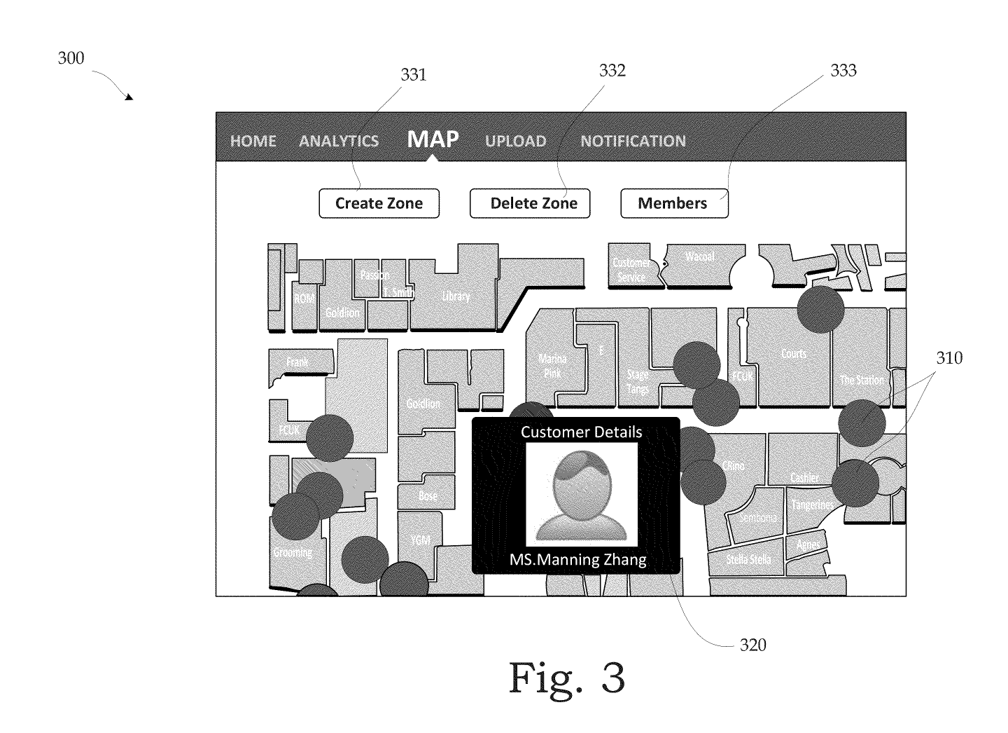

At 210, location awareness module 122 may stream the customer information and location proximity to one or more client devices 150 to notify retailers of the presence of one or more customers whose registered customer device(s) 140 has been detected within the shopping establishment. In some implementations, the customer information and/or location proximity that is detected by sensors 160 is presented via a dashboard at client devices 150 to indicate the presence and location of a customer. FIG. 3 illustrates an exemplary dashboard 300 presented at client device 150 that shows the presence of one or more customers in the shopping establishment. In some cases, the location awareness module 122 may alert the retail personnel of the presence of customers by presenting indicators 310 on the dashboard 300.

In one implementation, the dashboard 300 may include multiple option selectors such as create zone 331, delete zone 332, and members 333 as depicted in FIG. 3. For instance, create zone 331 enables retail personnel to create and/or configure a viewing zone for viewing customers that are detected by sensors 160 in the shopping establishment, while delete zone 332 enables retail personnel to delete a zone from view. The option members 333 may enable a retail personnel to identify customers that are members of that particular retailer's loyalty program. For example, by selecting of the option members 333, additional indicators may be included in the dashboard 300 to indicate that one or more of the detected customers 310 are also members of that particular retailer's loyalty program. In other instances, a selection of the option members 333 may present a different view to show only detected on-premise customers that are members of a particular retailer's loyalty program.

The location awareness module 122 may present, via the dashboard, the retrieveable customer information. For instance, a pop-up 320 may appear as the retail personnel, for example, hovers an interface control over an indicator 310 of a customer. The pop-up 320 may include personal information of that customer such as, for example, name, photo, etc. The extent of the information detail presented via the dashboard may be configured, for example, by a retail manager of the client device 150.

At 212, the product management module 128 may present one or more product informational messages to the customer. The product informational messages may include promotional product advertisements, product catalogue, notifications, etc. In some implementations, the product management module 128 may include an advertisement management component that may serve to present advertisements (e.g., promotions, personalized offers, new product, restocked product availabilty, etc.) to potential customers. Each advertisement includes text and/or graphics designed to attract customer attention or patronage (e.g., notifications of limited time offers, description of goods for sale, etc.).

The product management module 128 may be configured to automatically present advertisements that are stored in client device 150 or in a retail operator's database 118. For example, the advertisement management component may be configured by a retail operator to automatically select relevant advertisements based on, for instance, the customer information and one or more predefined criteria-based rules. For example, if the customer is a female of a particular ethnicity, advertisements on ethnic wears and related items may then be presented. Other criteria may also be useful for selecting advertisements to be presented. For example, the advertisement may be selected based on market segment that the customer may belong to.

The advertisement may be automatically generated based on one or more criteria corresponding to the customer information. For example, the advertisement may be based on a popular item, personalized based on customer profile, targeted based on relevance with customer information, etc. The advertisement management component may calculate a relevance score for each advertisement based on one or more scoring factors to determine the advertisements most relevant to the user. For example, scoring factors may be determined based on customer purchase history, interests indicated by the customer (e.g., latest fashion trends), search history (e.g., search for a particular group of related items), historical data (e.g., previous successful advertisements that were pushed to the user), and so forth. The intelligence in the advertisement management component may assist in finding the appropriate advertisement for the customer, for example, from an advertisement repository.

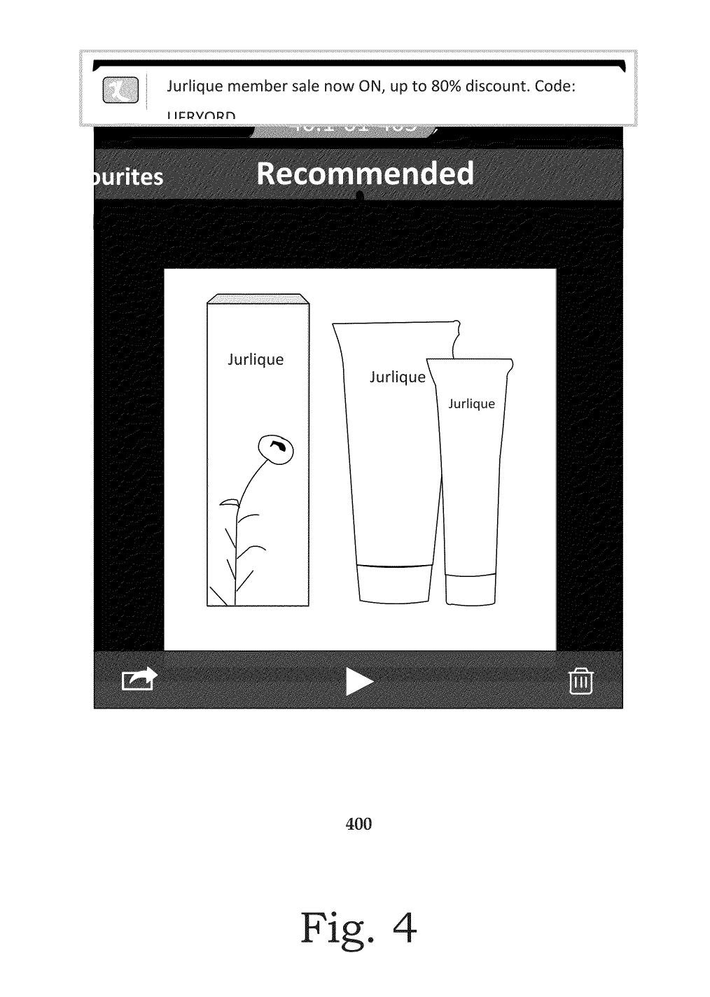

FIG. 4 illustrates an exemplary promotion-based advertisement that may be presented to a customer via the customer device 140. The advertisement may be presented by, for example, a push notification on the user device 140 or displayed while the user is interacting with the mobile application 142. Other methods of presenting the advertisements are also useful. In some instances, the advertisement may include an option to be re-directed to the retailer's product catalogue. The product catalogue may include information of products that are offered by a retailer. For example, the product catalogue may include information such as specification, pricing, quantity, and manufacturers. Other product information may also be useful. In some implementations, the product catalogue is made available to customers who may not necessarily be on-premise. For example, customers may view the product catalogue from home via mobile application 142 or a retailer's web browser.

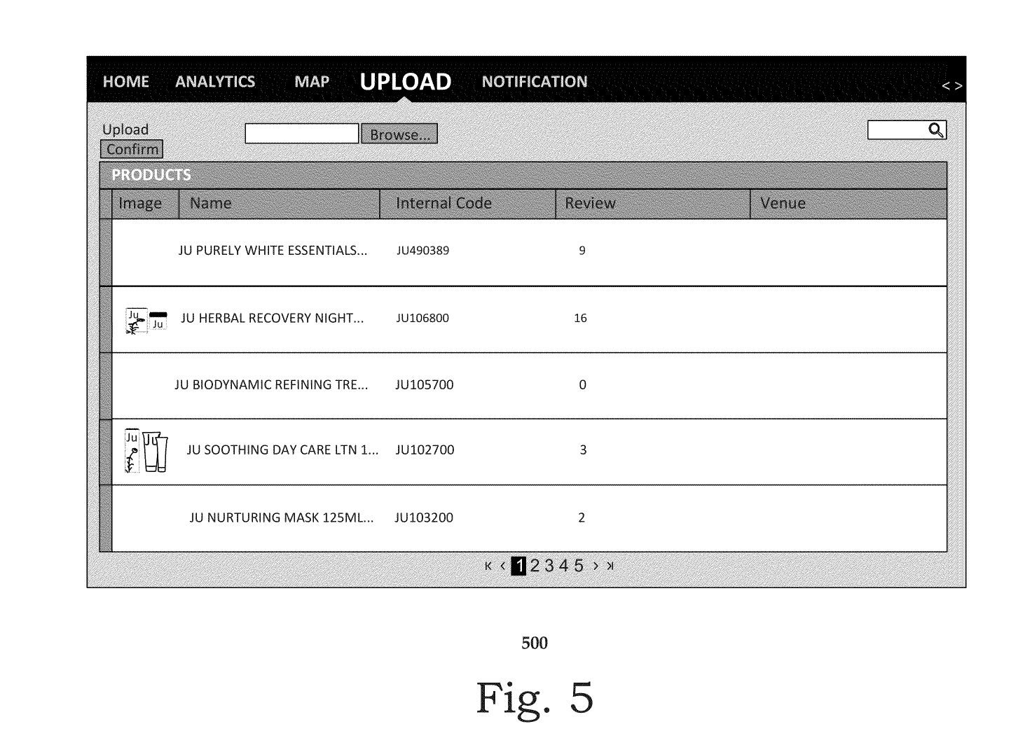

In other implementations, the advertisements may be manually created or selected from the retail operator's advertisement repository. The advertisement repository may be located in computer system 102, client device 150 or database 118. FIG. 5 shows an exemplary dashboard 500 presented at client device 150 for uploading a promotional product advertisement to the advertisement repository. The dashboard 500 may also include advertisement information such as product name, image, internal code, number of reviews and venue.

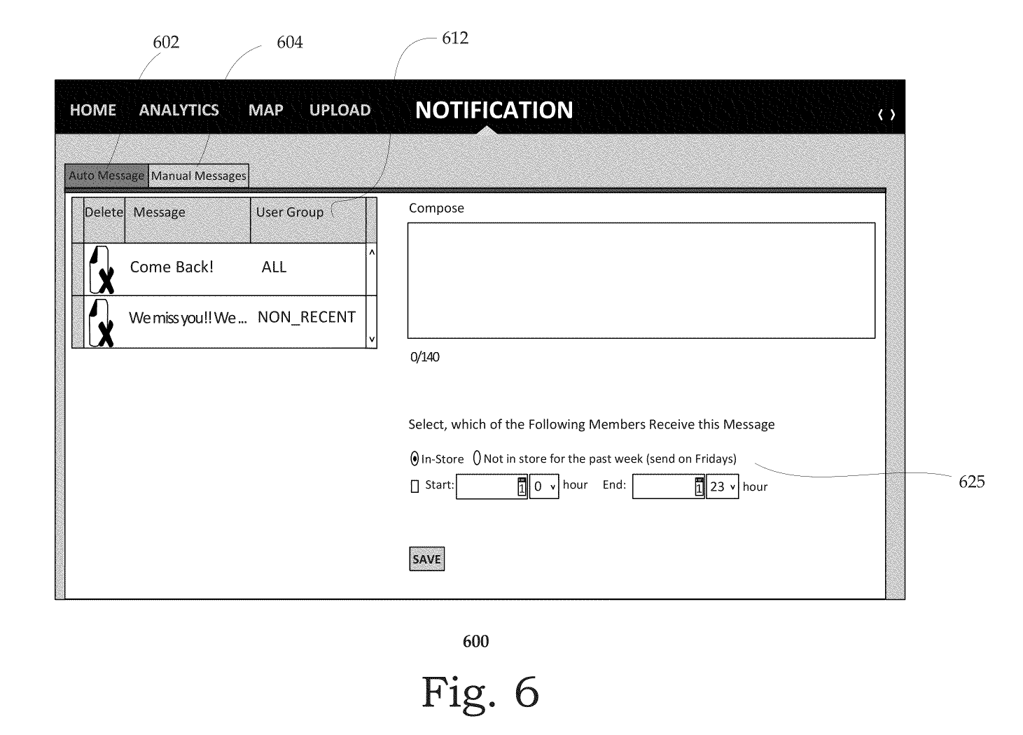

FIG. 6 illustrates an exemplary dashboard 600 that allows configuration of notifications to be sent to customers. As described, the product management module 128 allows a retail personnel to present product informational messages to customers automatically, manually or both. For example, dashboard 600 may include options such as auto messages 602 folder where notifications configured in that setting may be automatically sent by shopping assistance system 120 upon detecting a customer. The notification may be sent, for instance, to a specific user group 612 as defined by the retail personnel. Manual messages 604 folder may include notifications that may be sent manually by a retail personnel. As depicted in dashboard 600, the product management module 128 enables a retail personal to compose notification messages. The dashboard 600 may further include settings 625 to configure recipients of the notification message. The composed notification message may be managed and stored in the advertisement repository.

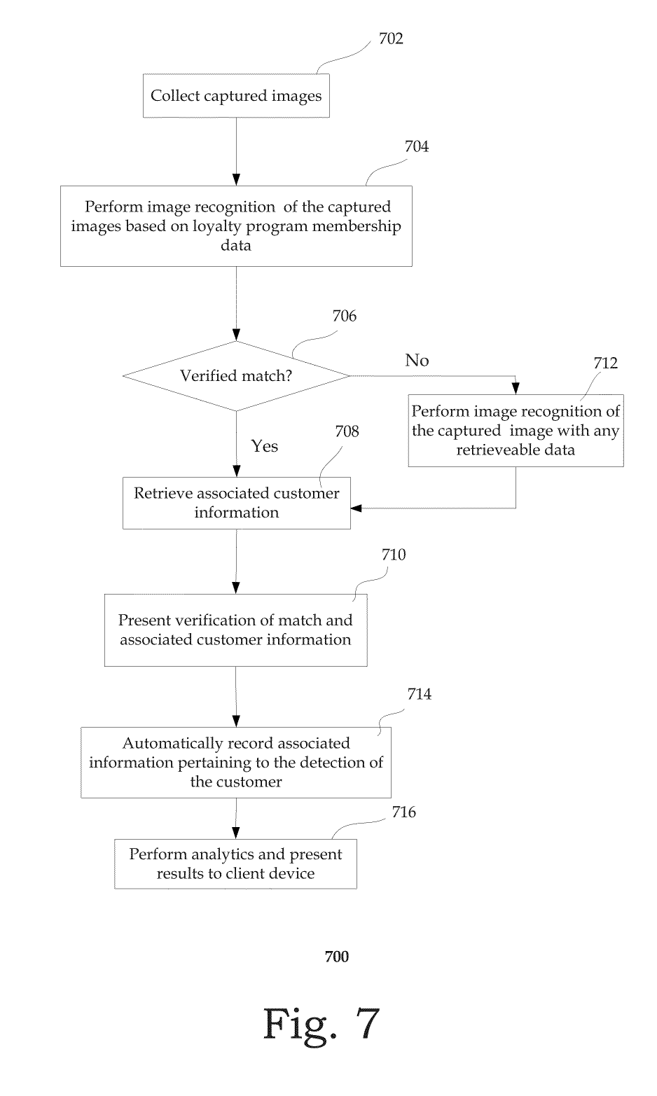

FIG. 7 shows an exemplary method 700 of providing shopping assistance based on image recognition. The method 700 may be performed automatically or semi-automatically by the system 100, as previously described with reference to FIG. 1. It should be noted that in the following discussion, reference will be made, using like numerals, to the features described in FIG. 1.

At 702, the image recognition module 126 may collect captured images of customers from sensors 160 and perform face detection of the captured images of customers (e.g., detection of facial features). The images of the customers may be captured by, for instance, image capture devices 160 (e.g., camera, wearable devices with image sensors, mobile phones, etc.). In one implementation, image capture devices 160 may be positioned strategically in a retail store. The image capture devices 160 may continuously capture images as it detects, for example, faces of a customer in a particular retail store. In other implementations, the image capture devices 160 may be wearable devices that are worn by one or more retail personnels. For instance, a wearable device may capture images of, for example, an in-store customer as the wearable device is directed at the customer while a retail personnel approaches that customer or is within an image sensing range to that customer. In yet other implementations, the image capture devices 160 may be mobile devices installed with imaging features that may be handheld and positioned by a retail personnel to capture images of customers in a retail store.

At 704, the image recognition module 126 may perform image recognition for the detected face of the captured images. In one aspect, a facial recognition algorithm may be employed to determine the identity of a customer of the captured image. Such determination may be made by, for instance, matching the captured image with images (e.g., facial images) that may be retrieved by loyalty program module 124, for example, from loyalty program membership data stored in computer system 102 or database 118.

At 706, the image recognition module 126 may perform verification of a match between the captured image of the in-store customer with, for example, images from the loyalty program membership data. Upon determining a match, at 708, the loyalty program module 124 may automatically retrieve information associated with that customer. For instance, the associated customer information may be retrieved from the loyalty program membership data based on the matching images. In some instances, associated customer information may further be retrieved from data sources 118 such as, for example, retailer information systems, and social network sites. At 710, the image recognition module 126 may present a verification of the match to client device 150. A match may indicate that a customer registered to a loyalty program is recognized to be in-store. The verification may include the identity of the customer with a sufficient confidence score. The verification based on the captured image of the in-store customer with the loyalty program membership data provides a certain confidence of that recognized customer.

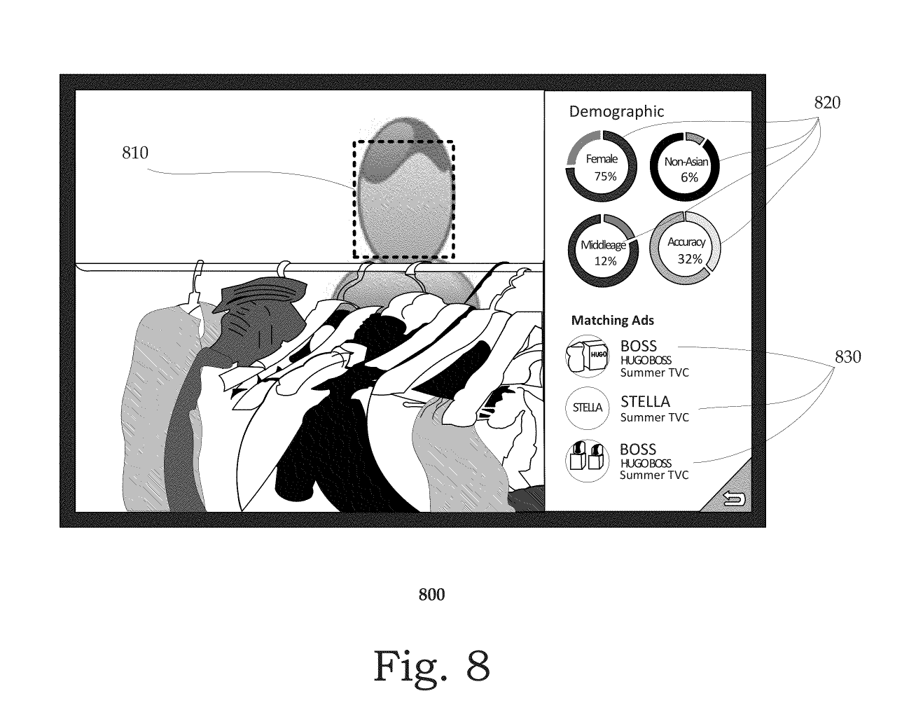

FIG. 8 illustrates an exemplary dashboard 800 presented at client device 150 that shows a recognized image of a customer and the associated customer information. For instance, the system 120 may present a dashboard 800 with an icon 810 outlining the face of the customer. The dashboard 800 may include the associated customer information by indicators 820 such as sex, age group, race, and accuracy of the recognition. In some implementations, the shopping assistance system 120 may further suggest relevant product recommendations based on the customer's profile as depicted by icons 830. The verification may facilitate a retail personnel in recognizing a customer and determining the associated customer's preferences based on his or her information. Such information may assist a retail personnel in determining relevant product recommendations so as to effectively engage the customer. Furthermore, the verification of a match of the captured image data of a registered customer may serve to augment the location proximity information of a detected customer device 140 that indicates the presence of a registered customer in a retail store.

Returning to FIG. 7, if the image recognition module 126 is unable to verify a match between the captured image and the images from loyalty program membership data, at 712, the image recognition module 126 may perform image recognition against data that may be searchable from one or more data sources 118. For example, a facial recognition tool, based on, for instance, web-based photo applications may match the captured image with online photos from social-networking sites. If the image recognition module 126 identifies a match between the captured image and any searchable image from data sources 118, at 708, the image recognition module 126 may further retrieve any associated customer information from data sources 118, and at 710, present the retrievable information to client device 150. For instance, customer information such as demographics (e.g, gender, age group, accuracy of detection) and relevant product recommendations may be presented.

In some implementations, the framework may be used to detect retail personnels. For example, location proximity of a retail personnel may be determined by detecting a mobile client device 150 that is associated with that retail personnel using sensors 160 as described with respect to the detection of customers. In some aspects, image recognition may further be employed to recognize and identify a retail personnel. Information related to retail personnel location may be used to match with location of detected customers. For example, in location where registered customers are detected, the shopping assistance system 120 may assist in determining that a retail personnel is nearby to provide services to the customer.

At 714, the shopping assistance system 120 may automatically record any information pertaining to the detection of the customer such as, for example, transactions corresponding to the customer's visit. The shopping assistance system 120 may record information of customer purchases and visits over time and store such information at client device 150, computer system 102 or in a remote retail operator's database 118. In some cases, the shopping assistance system 120 may also record any information associated to the interaction between a retail personnel and the customer. For instance, the shopping assistance system 120 may record information such as a product(s) purchased by the customer, due to a recommendation by the retail personnel to that customer.

At 716, the shopping assistance system 120 may invoke data analytics module 129 to perform real time analyses of, for example, any information corresponding to the detection of customers. For example, the data analytics module 129 may retrieve sales transaction from a POS system and analyze against the number of on-site customer visits from sensors 160 to provide real time in-store conversion rates. The data analytics module 129 may also analyze customers past purchase behaviour and further use that information to personalize a promotion for that customer. Such analyses may facilitate retail associates in determining, among other things, promotions and engagement effectiveness in real time. In other instances, data analytics module 129 may also perform real time analyses of customer searches such as most searched product.

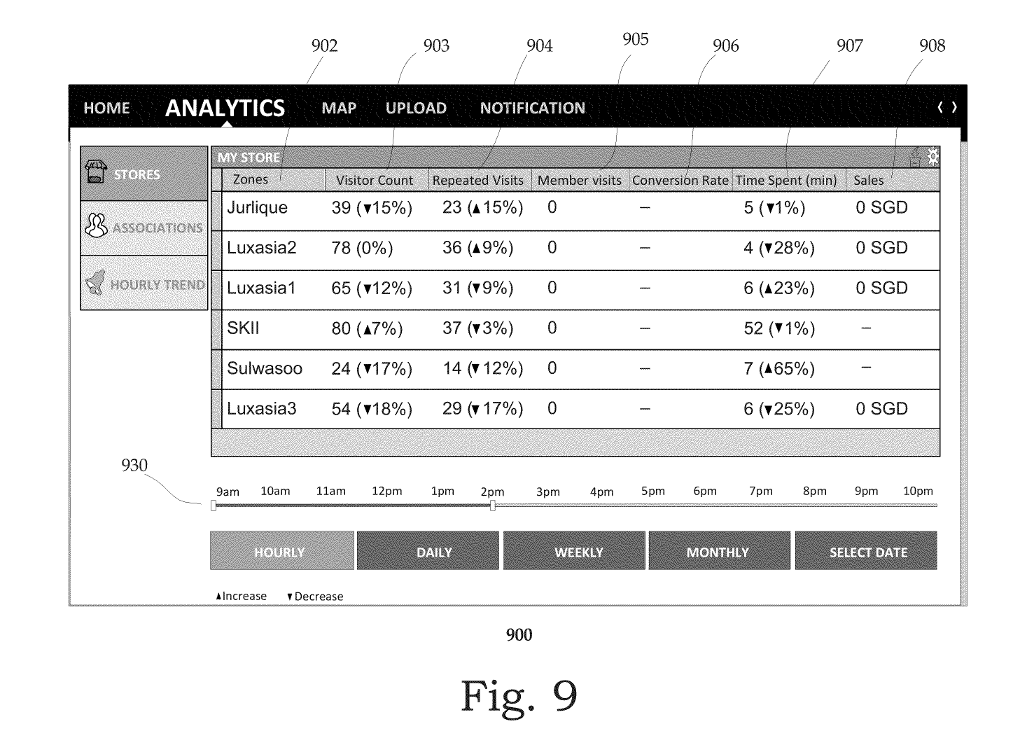

FIG. 9 illustrates an exemplary dashboard 900 of an analytics report of real time analyses of customer visits for a retail operator presented at the client device 150. As illustrated, the report may include information such as zones 902, visitor count 903, repeated visits 904, member visits 905, conversion rate 906, time spent 907 and sales 908. Zones 902 may include a group of product brands managed by the retail operator. The visitor count 903, repeated visits 904, member visits 905, conversion rate 906, time spent 907 and sales 908 may be itemized according the product brand. The report may further include an option 930 that allows a retail personnel to view the analyses of customer visits based on a time bar. Other analytics report may also be useful. For example, other analytics metrics that may be useful are correlation between visits and sales volume (number of items purchased or median item weight as opposed to the dollar sales amount), density of sales personnel in each zone and its correlations with sales, ratio of sales personnel to customers in each zone and its effect on sales.

Other types of analyses may also be useful. For example, analyses may also be performed on customer movement within a retail space, how long they stay in a zone, and ability of each zone in the retail space to convert customer visits to hard sales. In some instances, customer visit patterns, such as customers flow from one zone to another may be determined. In one aspect, customer engagement effectiveness, where sales personnel proactively approach customers to service them and how effective the sales personnel are may further be determined. In another example, footflow analysis may be performed to determine the number of customers that passes by a retail space, versus the number of customers that stops by, the number of customers that convert to make a purchase and eventually the value of their purchases. In yet another example, real-time demographics such as estimated age, gender, dress style, etc., obtained from sensors 160 may be cross-referenced with footfall analytics and/or transaction data.

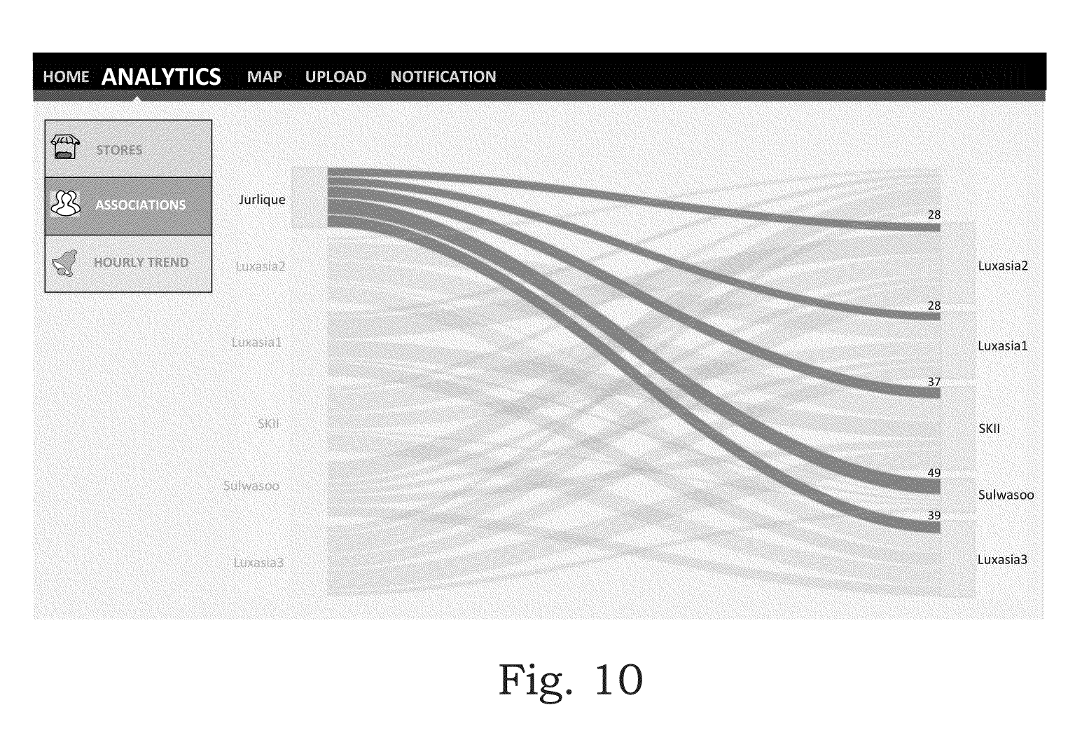

FIG. 10 illustrates another exemplary dashboard 1000 of an analytics report of a footfall flow graph. As depicted in this particular example dashboard, of those customers who visited the Jurlique zone, 28 went to the Luxasia2 zone, another 28 went to the Luxasia1 zone, 37 proceeded to the SKII zone, 49 to the Sulwasoo zone, and 39 to the Luxasia3 zone. The zones as shown in dashboard 1000 are areas within a retail space that are defined, for example, by a retail store manager and are used to identify the brands or types of merchandises sold within each area. It should be appreciated that other types of analytics and reports may also be employed in accordance with the present framework.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

What is claimed is:

1. A method of shopping assistance, comprising:
detecting, by a processor, a customer in an establishment, wherein detecting the customer comprises performing, based on one or more data sources, image recognition of a captured image of the customer;
retrieving, from the one or more data sources, customer information associated to the customer;
presenting, via a client device, a verification of the customer and the associated customer information;
performing real-time analytics based at least in part on data associated to the detection of the customer in the establishment; and
presenting, via the client device, results of the analytics.

2. The method of claim 1 wherein detecting the presence of the customer further comprises:
monitoring, via location sensors, location proximity data of one or more customer devices;
determining from the one or more customer devices, a customer registered to a loyalty program membership;
in response to determining a customer to be a registered member of the loyalty program, retrieving customer information associated to the customer; and
presenting, via the client device, notification of the location proximity data and the associated customer information.

3. The method of claim 2 wherein the one or more data sources include loyalty program membership data.

4. The method of claim 3 wherein retrieving the customer information includes retrieving the customer information from the loyalty program membership data.

5. The method of claim 2 further comprising, in response to determining the customer to be a registered member of the loyalty program, automatically presenting an advertisement to the customer.

6. The method of claim 5 further comprising presenting an advertisement to the customer based on the customer information and one or more criteria-defined rules.

7. The method of claim 2 further comprising detecting a retail personnel, wherein detecting the retail personnel comprises monitoring location proximity data of the retail personnel.

8. The method of claim 7 wherein performing real-time analytics further comprises performing real-time analysis based on information associated to the interaction between the retail personnel and the customer.

9. The method of claim 1 wherein the captured image is obtained by capturing, via image sensors, an image of the customer in a retail space.

10. The method of claim 1 wherein the one or more data sources comprises a loyalty program membership data that includes the associated customer information.

11. The method of claim 10 wherein performing image recognition of the captured image includes performing image recognition against images of registered customers stored in the loyalty program membership data.

12. The method of claim 11 wherein presenting a verification of the customer and the associated customer information includes an identification of the customer with a sufficient confidence score.

13. The method of claim 10 wherein performing image recognition of the captured image includes performing image recognition against images retrievable from the one or more data sources.

14. The method of claim 1 wherein retrieving the customer information includes retrieving, from a loyalty program membership database, customer membership information, purchase history, shopping list or a combination thereof

15. The method of claim 1 wherein performing the real time analytics include determining a store conversion rate in real time.

16. A system for shopping assistance, comprising:
a location awareness module for detecting the presence of a customer in an establishment, wherein the location awareness module determines a location proximity of the customer;
a loyalty program module for determining the membership of the customer to a loyalty program;
an image recognition module for performing image recognition of captured images of customers in a particular retail space; and
an analytics module for analyzing information associated to the detection of the customer in the establishment and a recognized captured image.

17. The system of claim 16 wherein the image recognition module performs image recognition of captured images against images retrieved from a loyalty program membership data.

18. The system of claim 16, further comprising a product management module arranged to present advertisements to the customer.

19. A computer usable medium having a computer readable program code tangibly embodied therein, the computer readable program code adapted to be executed by a processor to implement a method of shopping assistance comprising:
determining location proximity data of one or more detected customer-registered devices in an establishment;
performing, based on one or more data sources, image recognition of a captured image of a customer;
retrieving, from the one or more data sources, customer information associated to the customer;
performing real-time analytics based at least in part on the location proximity data and the retrieved customer information; and
presenting, via a client device, a notification based on the location proximity data, a verification of the customer and the associated customer information, and results of the analytics.

20. The computer usable medium of claim 19 further comprising presenting an advertisement to a customer-registered device based on one or more criteria-defined rules.
